(19) United States
(12) Patent Application Publication
(10) Pub. No.: US 2013/0199699 A1
(43) Pub. Date: Aug. 8, 2013

(54) Conductive Adhesive For A Floorcovering

(71) Applicants: Alfred Huf, Eichenried (DE); Gunnar Ernst, Augsburg (DE)

(72) Inventors: Alfred Huf, Eichenried (DE); Gunnar Ernst, Augsburg (DE)

(73) Assignee: CONSTRUCTION RESEARCH & TECHNOLOGY GMBH, Trostberg (DE)

(21) Appl. No.: 13/637,783

(22) PCT Filed: Mar. 31, 2011
(86) PCT No.: PCT/EP11/54990

§ 371 Date: Nov. 9, 2012

(30) Foreign Application Priority Data
Apr. 8, 2010 (EP) 10159325.9

(51) Int. Cl. C09J 9/02; E04F 13/00

(52) U.S. Cl. CPC C09J 9/02; E04F 13/00
USPC 156/71; 252/511

(57) ABSTRACT

The invention relates to an adhesive for a floorcovering, comprising, based on the entire adhesive, from 5 to 30% by weight of at least one component selected from graphite and carbon black and/or from 0.2 to 3% by weight of conductive carbon fibers, from 25 to 50% by weight of a polyurethane dispersion with solids content of from 25 to 65% by weight, where less than 5% by weight of an aqueous dispersion of polyhydroxyether polymer, grafted with at least one acrylic or methacrylic monomer, with solids content of from 25 to 40% by weight, is present.

The present invention relates to a conductive adhesive for a floorcovering and to use thereof.

For the purposes of the invention, adhesives for a floorcovering are adhesives which are suitable for the adhesive bonding of coverings on substrates. These coverings can be composed of synthetic materials (textile wall-to-wall carpets, PVC coverings, rubber coverings, etc.), natural materials (cork or wood, etc.) or a mixture thereof (linoleum). For reasons related to the environment and also to legislation on health and safety at work, adhesives of this type are nowadays preferably formulated on the basis of low-emission, aqueous polymer dispersions. By way of example, mention may be made of WO 2007141198, WO 03068885, WO03025082 (PVC tiles), EP 0 221 461, US 2005113499, DE 19801892 and DE 4 404 411 for the constitution of the said adhesives.

Adhesives based on aqueous polyurethane dispersions have become established worldwide in high-performance industrial applications, for example in shoe manufacture, in the adhesive bonding of parts for the interior trim of motor vehicles, in foil lamination or in the adhesive bonding of textile substrates. The production of aqueous polyurethane and, respectively, polyurethane polyurea dispersions for adhesive applications is known. By way of example, DE 38 27 378, DE 39 42 681 and U.S. Pat. No. 5,652,288 also disclose aqueous polyurethane dispersions as adhesives. However, formulations based on polyurethane dispersions have been little used hitherto as adhesive for a floorcovering, and a prime reason for this may be that they are relatively expensive.

Conductive floorcoverings are used in particular in computer rooms and, in order to increase conductivity, conductive adhesives are also used for adhesive bonding of these to the floors (in which connection see the technical briefing note TKB-7, 5.5.3). A disadvantage of the aqueous, conductive adhesives disclosed hitherto is that once the adhesive and floorcovering has been installed the conductivity of these falls substantially during the course of the use and aging, and then often fails to comply with the relevant requirements.

It is known that adhesives can be rendered electrically conductive by incorporating electrically conductive substances such as carbon black or graphite. However, as mentioned above, a time-dependent reduction of electrical conductivity is observed here when floorcovering adhesives based on conventional aqueous polymer dispersions are used, the result being that after a few months the adhesives then lack the full capability required for dissipation of electrical charges. By way of example, EP 0 276 691 discloses aqueous adhesives of this type which are also suitable for floorcoverings.

It was therefore an object of the present invention to develop low-emission adhesives which have good adhesive action for various floorcoverings and which have long-lasting electrical conductivity, so that any electrostatic charges generated can be reliably dissipated from the adhesive-bonded materials. Variants of the said adhesive were moreover intended not only to permit dissipation of electrostatic charge but indeed, in conjunction with suitable materials on which the adhesive is to be used, to retain the insulative effect of these materials. This prevents injury to people who unintentionally come into contact with live parts during work with exposed live equipment. When this type of adhesive is used in conjunction with suitable materials for adhesive bonding therewith, e.g. appropriately conductive floorcoverings, the dissipation of charge is therefore analogous to that in DIN 51 953 and DIN 16 860 and at the same time the insulation requirement of the VDE 0 100 specification is satisfied.

The adhesive should moreover have high initial tack, alongside the above-mentioned properties. Initial tack means that when the adhesive layer has been freshly applied to a substrate it permits secure full-surface-area bonding of sheet materials to the substrate, even when these are subject to internal stress. That means that, even if the adhesive itself has not yet set, there is no subsequent release of the covering from the adhesive layer.

The said object is achieved via an adhesive for a floorcovering, comprising, based on the entire adhesive, from 5 to 30% by weight of at least one component selected from graphite and carbon black and/or from 0.2 to 3% by weight of conductive carbon fibres, from 25 to 50% by weight of a polyurethane dispersion with solids content of from 25 to 65% by weight, where less than 5% by weight of an aqueous dispersion of polyhydroxyether polymer, grafted with at least one acrylic or methacrylic monomer, with solids content of from 25 to 40% by weight, is present.

Surprisingly, it has been found that the adhesive according to the invention exhibits very little reduction of conductivity, even over a prolonged period, and that a significant advantage is therefore achieved over the prior art.

Polyurethane dispersions that can be used are aqueous polymer dispersions based on polyester polyurethane, polyether polyurethane or acrylate polyurethane. However, it is also possible to use polyurethane dispersions by way of example based on polythioether, polylactone, polyacetal, polycarbonate or polyesteramide. Preference is given to polyester polyurethane dispersions, in particular resin-modified polyester polyurethane dispersions.

Structural components of the polyurethane for the use according to the invention are in essence polyisocyanates and di- or polyhydroxy compounds.

Suitable polyisocyanates are in particular aliphatic, cycloaliphatic and aromatic diisocyanates. It is preferable to use those with the general formula X(NCO)₂, where X is an aliphatic hydrocarbon moiety having from 4 to 12 carbon atoms, a cycloaliphatic moiety having from 6 to 15 atoms or an aromatic hydrocarbon moiety having from 7 to 15 carbon atoms.

Examples of suitable aliphatic, cycloaliphatic and aromatic diisocyanates are hexamethylene 1,6-diisocyanate (HDI), 1-isocyanato-3,3,5-trimethyl-5-isocyanatomethylcyclohexane (IPDI), tolylene 2,4- and/or 2,6-diisocyanate (TDI) and/or diphenylmethane 4,4′-, 2,4′- and/or 2,2′-diisocyanate (MDI), m-xylene diisocyanate (MXDI), m- or p-tetramethylxylene diisocyanate (m-TMXDI, p-TMXDI), dicyclohexylmethane 4,4′-diisocyanate (H12MDI), naphthalene 1,5-diisocyanate, cyclohexane 1,4-diisocyanate, hydrogenated xylylene diisocyanate (H6XDI), 1-methyl-2,4-diisocyanatocyclohexane, tetramethoxybutane 1,4-diisocyanate, butane 1,4-diisocyanate, 1,6-diisocyanato-2,2,4-trimethylhexane, 1,6-diisocyanato-2,4,4-trimethylhexane, 1-isocyanato-1-methyl-4(3)-isocyanatomethylcyclohexane (IMCI), and also dodecane 1,12-diisocyanate (C12DI).

It is also possible to use mixtures of the diisocyanates. Mixtures of aliphatic and, respectively, cycloaliphatic diisocyanates with aromatic diisocyanates in a molar ratio of from 1:4 to 5:1 have proven to be particularly suitable.

Subordinate amounts of monoisocyanates can also be used for molecular-weight regulation, alongside the diisocyanates.

The molar mass of the di- or polyhydroxy compounds is preferably from 400 to 16 000 g/mol. Compounds which—at room temperature—are liquid, or are glassy and solid/amorphous or crystalline are suitable. Typical examples that may be mentioned are difunctional polypropylene glycols. It is also possible to use hydroxylated random copolymers and/or block copolymers of ethylene oxide and of propylene oxide. Suitable polyether polyols are the polyethers known per se in polyurethane chemistry, for example the polyols produced from styrene oxide, propylene oxide, butylene oxide, tetrahydrofuran or epichlorohydrin, by using starter molecules. Specifically, other suitable compounds are poly(oxytetramethylene)glycol (polyTHF), 1,2-polybutylene glycol, or a mixture of these. Particularly suitable compounds are polypropylene oxide and polyethylene oxide and mixtures of these. Another type of copolymer that can be used as polyol component and that has terminal hydroxy groups corresponds to the following general formula (capable of production, for example, by “controlled” high-speed anionic polymerization according to Macromolecules 2004, 37, 4038-4043):

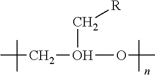

in which R is identical or different and preferably is OMe, OiPr, Cl or Br.

The polyesterdiols are preferably reaction products of dihydric alcohols with dibasic carboxylic acids. Instead of the free dicarboxylic acids, it is also possible to use the corresponding dicarboxylic anhydrides or corresponding dicarboxylic esters of lower alcohols, or a mixture of these, to produce the polyesterdiols.

Polyesters which—at 25° C.—are liquid, or are glassy and solid/amorphous or crystalline are a suitable di- or polyol component, where these polyesters can be produced via condensation of di- or tricarboxylic acids, e.g. adipic acid, succinic acid, maleic acid, fumaric acid, sebacic acid, glutaric acid, azelaic acid, suberic acid, undecanedioic acid, dodecanedioic acid, 3,3-dimethylglutaric acid, phthalic acid, terephthalic acid, isophthalic acid, hexahydrophthalic acid and/or dimer fatty acid, with low-molecular-weight diols and, respectively, triols, e.g. ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol and/or trimethylolpropane.

Another suitable group of the polyols is that of the polyesters by way of example based on caprolactone, these also being termed “polycaprolactones”. Other polyols that can be used are polycarbonate polyols and dimerdiols, and also polyols based on vegetable oils and derivatives of these, for example castor oil and derivatives thereof, or epoxidized soya bean oil. It is also possible to use polycarbonates having hydroxy groups, these being obtainable via reaction of carbonic acid derivatives, e.g. diphenyl carbonate, dimethyl carbonate or phosgene, with diols. Specifically suitable compounds are ethylene glycol, 1,2- and 1,3-propanediol, 1,3- and 1,4-butanediol, 1,6-hexanediol, 1,8-octanediol, neopentyl glycol, 1,4-bishydroxymethylcyclohexane, 2-methyl-1,3-propanediol, 2,2,4-trimethyl-1,3-pentanediol, dipropylene glycol, polypropylene glycols, dibutylene glycol, polybutylene glycols, bisphenol A, tetrabromobisphenol A, glycerol, trimethylolpropane, 1,2,6-hexanetriol, 1,2,4-butanetriol, trimethylolpropane, pentaerythritol, quinitol, mannitol, sorbitol, methyl glycoside and 1,3,4,6-dianhydrohexitols. Other compounds that can be used as polyols are the hydroxy-functional polybutadienes which can be purchased inter alia as “Poly-bd®”, and also the hydrogenated analogs of these. It is also possible to use hydroxy-functional polysulphides which are marketed as “Thiokol® NPS-282” and also hydroxy-functional polysiloxanes.

The proportion of the di or polyhydroxy compounds with molar mass of from 400 to 16 000 g/mol is in particular selected in such a way that the amount used of the dihydroxy compound for each gram equivalent of isocyanate is from 0.1 to 0.8, equivalent by weight, particularly preferably from 0.15 to 0.6 equivalent by weight.

The structure of the polyurethane preferably uses chain extenders, in particular with molar mass below 400 g/mol. These are in essence compounds which comprise two hydroxy groups, two primary or secondary amino groups, or one hydroxy group and one primary or secondary amino group. Examples of compounds that can be used are the alcohols suitable for producing the polyesterdiols, diamines, such as ethylenediamine, hexamethylenediamine, piperazine, 2,5-dimethylpiperazine, 1-amino-3-aminomethyl-3,5,5-trimethylcyclohexane (isophoronediamine), 4,4′-diaminodicyclohexylmethane, 2,4-diaminocyclohexane, 1,2-diaminopropane, hydrazine, or aminoalcohols, such as ethanolamine, isopropanolamine, methylethanolamine or aminoethoxyethanol.

The proportion of the chain extenders, based on 1 gram equivalent of isocyanate, is preferably from 0.1 to 0.8 gram equivalent, particularly preferably from 0 to 0.7 gram equivalent.

It is also possible to make concomitant use of structural components which comprise more than two functional groups reactive towards isocyanate, and in this case the compounds act not only as chain extenders but also as crosslinking agents. An example that may be mentioned is diethylenetriamine or 1,8-diamino-4-aminomethyloctane.

The proportion of the said crosslinking agent, per gram equivalent of isocyanate, is generally from 0 to 0.4 gram equivalent, in particular from 0 to 0.1 gram equivalent.

It is also possible to use hydrophilic compounds that have dispersing effect. These are unlike the structural components described above in comprising hydrophilic groups that have dispersing effect. They are in particular compounds having an ionic group or having a group that can be converted into an ionic group, and at least one group reactive towards isocyanate.

Examples of suitable compounds are aliphatic, cycloaliphatic or aromatic mono- or dihydroxycarboxylic acids. Preference is given to dihydroxyalkylcarboxylic acids, in particular having from 3 to 10 carbon atoms, as also described in U.S. Pat. No. 3,412,054. Particular preference is given to compounds of the general formula

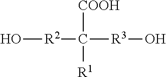

in which R¹ is a hydrogen atom or an alkyl moiety having from 1 to 4 carbon atoms and R² and also R³ are a C₁-C₄-alkylene group. 2,2-Dimethylolpropionic acid may be mentioned by way of example.

Other compounds worthy of mention are aminosulphonic acids or aminocarboxylic acids, and also tertiary ammonium salts comprising one or two hydroxy groups and, respectively, amino groups, e.g. lysine, beta-alanine, N-(2-aminoethyl)-2-aminoethanesulphonic acid, and the adducts, mentioned in DE-A-20 34 479, of aliphatic diprimary diamines onto α-olefinic carboxylic acids, e.g. the adduct of ethylenediamine onto acrylic acid.

For conversion of potential anionic groups, e.g. carboxylic acid groups or sulphonic acid groups, into ionic groups it is possible to use inorganic and/or organic bases, for example sodium hydroxide, potassium hydroxide, potassium carbonate, sodium hydrogencarbonate, ammonia, or primary, secondary, and particularly tertiary, amines, e.g. triethylamine or dimethylaminopropanol.

For conversion of the potentially cationic groups, e.g. of the tertiary amino groups, into the corresponding cations, e.g. ammonium groups, inorganic or organic acids can be used as neutralizing agents, e.g. hydrochloric acid, acetic acid, fumaric acid, maleic acid, lactic acid, tartaric acid, oxalic acid or phosphoric acid, or by way of example methyl chloride, methyl iodide, dimethyl sulphate, benzyl chloride, ethyl chloroacetate or bromoacetamide can be used as quaternizing agents. Other suitable neutralizing and quaternizing agents are described by way of example in column 6 of U.S. Pat. No. 3,479,310.

It is also possible, if appropriate, to use nonionic emulsifiers as hydrophilic compounds with dispersing effect, examples being polyether alcohols in the molar-mass range from 500 to 20 000 g/mol, preferably from 1000 to 5000 g/mol.

The hydrophilic compound with dispersing effect ensures that the polyurethane is dispersible in water. The proportion thereof, based on one gram equivalent of isocyanate, is preferably from 0.03 to 0.5 gram equivalent, in particular from 0.05 to 0.4 gram equivalent.

Based on one gram equivalent of isocyanate, the proportions of the structural components of the polyurethane are in particular selected in such a way that the entirety of the functional groups reactive towards isocyanate, i.e. the hydroxy groups or primary or secondary amino groups, is from 0.8 to 1.2 gram equivalent, preferably from 0.95 to 1.05 gram equivalent.

To produce the polyurethane, the structural components can by way of example be reacted in a low-boiling-point water-miscible organic solvent in a known manner, as also described by way of example in DE-A-34 37 918.

Examples of solvents that can be recommended are tetrahydrofuran, methyl ethyl ketone, and in particular acetone.

The reaction temperature is preferably from 50 to 100° C.

To accelerate the reaction of the diisocyanates, conventional and known catalysts can be used concomitantly, examples being dibutyltin dilaurate, stannous octoate or 1,4-diazabicyclo[2.2.2]octane.

The groups that can be converted into ionic groups are advantageously converted prior to or during the dispersion of the polyurethane in water.

After the dispersion process, the organic solvent is removed via distillation to the desired extent, generally almost entirely.

The polyurethane can also be produced by first producing a polyurethane prepolymer in the low-boiling-point water-miscible organic solvent.

The said prepolymer still has free isocyanate groups and preferably consists essentially of the polyisocyanate, the di- or polyhydroxy compound, the hydrophilic structural component with dispersing effect and, if appropriate, chain extenders and/or crosslinking agents. The convertible groups are in turn converted into ionic groups prior to or during the dispersion of the prepolymer in water.

After dispersion of the prepolymer in water, the isocyanate groups that are still free are then reacted with further proportions of chain extenders or crosslinking agents, these in particular being compounds having primary or secondary amino groups as group reactive towards isocyanate.

The solids content of the aqueous polyurethane dispersion is from 25 to 65% by weight, particularly preferably from 30 to 50% by weight.

The adhesive can preferably also comprise, based on the entire adhesive, from 1 to 20% by weight of a further polymer dispersion, based on C₁-C₂₀-alkyl(meth)acrylates, on vinyl esters of carboxylic acids, where these acids comprise from 1 to 20 carbon atoms, on vinylaromatics having from 1 to 20 carbon atoms, on ethylenically unsaturated nitriles, on vinyl halides, on non-aromatic hydrocarbons having at least 2 conjugated double bonds, or a mixture of the said monomers, and the polymers can comprise, based on solids content, from 0 to 40% by weight of further monomers, in particular monomers having functional groups.

Examples of individual compounds that may be mentioned are alkyl(meth)acrylates having a C1-C10-alkyl moiety, e.g. methyl methacrylate, methyl acrylate, n-butyl acrylate, ethyl acrylate and 2-ethylhexyl acrylate. Mixtures of the alkyl(meth)acrylates are also particularly suitable. Examples of vinyl esters of carboxylic acids having from 1 to 20 carbon atoms are vinyl laurate, vinyl stearate, vinyl propionate, vinyl versatate and vinyl acetate.

Vinylaromatic compounds that can be used are vinyltoluene, ortho- and para-methylstyrene, ortho-butylstyrene, 4-n-butylstyrene, 4-n-decylstyrene, and preferably styrene. Examples of nitriles are acrylonitrile and methacrylonitrile.

The vinyl halides are chlorine-, fluorine- or bromine-substituted ethylenically unsaturated compounds, preferably vinyl chloride and vinylidene chloride.

Non-aromatic hydrocarbons that may be mentioned that have from 2 to 8 carbon atoms and at least two olefinic double bonds are butadiene, isoprene, and chloroprene.

Particular preference is given to (meth)acrylates and mixtures of these.

Further monomers of which from 0 to 40% by weight, preferably from 0 to 20% by weight, and particularly preferably from 0.2 to 10% by weight, can be present in the further polymer dispersions, are C1-C10-hydroxyalkyl(meth)acrylates, (meth)acrylamide, and also derivatives thereof substituted by C1-C4-alkyl on the nitrogen, ethylenically unsaturated carboxylic acids, dicarboxylic acids, hemiesters of these and anhydrides e.g. (meth)acrylic acid, maleic acid, fumaric acid, maleic anhydride, maleic hemiesters and fumaric hemiesters, and itaconic acid. Very particular preference is given to content of from 0.2 to 5% by weight of an ethylenically unsaturated carboxylic acid.

The glass transition temperature of the polymer of the further polymer dispersion is preferably from −50 to 20° C., in particular from −35° C. to 20° C., particularly preferably from −30° C. to 0° C. and very particularly preferably from −28° C. to −5° C.

The glass transition temperature of the polymer can be determined by conventional methods, such as differential thermal analysis or differential scanning calorimetry (see, for example, ASTM 3418/82, the term used being “midpoint temperature”).

The solids content of the further polymer dispersion is preferably from 40 to 80% by weight, particularly preferably from 45 to 75% by weight. High polymer solids contents can by way of example be achieved by processes described in German Patent Application DE 43 07 683 or EP 37 923.

It is essential in the invention that the adhesive comprises an additive for increasing conductivity, this being at least one component from the group of graphite, carbon black and conductive carbon fibres. Graphite with an average particle diameter of from 10 to 70 μm has proved particularly successful.

The present invention uses the graphite in the form commercially available, and for purposes of incorporation the graphite can be processed in aqueous suspension with a wetting and dispersing agent. Suitable wetting and dispersing agents are inter alia adducts of ethylene oxide onto alkylphenol (e.g. nonylphenol), fatty alcohols or block copolymers of ethylene oxide on propylene oxide. Products that have proved successful in practice are adducts of from 4 to 30 mol of ethylene oxide/nonylphenol, in particular from 6 to 10 mol of ethylene oxide/nonylphenol and from 2 to 6 mol of ethylene oxide/fatty alcohol. It can also be advantageous, if appropriate, to make concomitant use of anionic wetting and dispersing agents, in addition to the nonionic wetting and dispersing agents. By way of example, these are sulphonation products of alkylbenzene or are sulphuric or phosphoric esters of fatty alcohols or of fatty-alcohol-ethylene-oxide adducts. An example that may be mentioned here is esterification products of 1 mol of phosphoric acid with 1 mol of adduct of oxyethylene groups onto fatty alcohol (molar ratio 6:1).

Concomitant use of conventional auxiliaries for dispersion adhesives is moreover advantageous in many instances. These are additions that affect viscosity, examples being inorganic salts (e.g. sodium hexametaphosphate), or are the alkali metal or ammonium salts of low-molecular-weight polyacrylic acid. It is also possible to use hydrocolloids, or else plasticizers (dibutyl phthalate, dioctyl phthalate, alkylsulphonic esters of phenols). It is, of course, also possible to use small amounts of low-boiling-point solvents (such as ethanol, isopropanol) in order to influence various performance characteristics.

Preservatives can also be used in the formulation of the adhesives, examples being phenolic compounds (o-phenylphenol or the sodium salt thereof, alkyl p-hydroxybenzoates, etc.), hexahydrotriazine derivatives, benzisothioazoline or dithiocarbamates.

If the intention is to use a spray method to apply the adhesives, additional use of an antifoam can be advisable. These antifoams are known and are commercially available, based on silicone, on mineral oil, on fatty alcohol or on polyalkylene glycols or on phosphoric esters. To ensure ideal compatibility of the adhesive and of its constituents, the pH should be adjusted by using ammonia or another regulant, to about 5 to 9.

Examples of amounts that can be present in the aqueous composition are from 0 to 5% by weight of wetting and/or dispersing agents, from 0 to 10% by weight of thickeners, from 0 to 1% by weight of preservatives and from 0 to 5% by weight of antifoams. The weight data here are based on the entirety of all of the constituents of the aqueous composition, with the exception of water.

The adhesive according to the invention can preferably comprise tackifying resins (tackifiers). The softening range of the tackifying resins can in particular be from 65 to 120° C. They can be of natural origin, as is the case for example with balsam resin, and can have been modified in a manner known per se. Modification processes that can be used are disproportionation processes, di- and polymerization processes, hydrogenation processes, diene addition processes using dienophiles, e.g. maleic anhydride, and esterification processes using glycol, polyethylene glycols, glycerol, pentaerythritol and similar alcohols. It is also possible to make use, or concomitant use, of hydrocarbon resins which have a softening point within the abovementioned range. In particular, these can be rosins or modified rosins, e.g. based on hydrogenated abietic acid or on abietic esters.

The content of tackifiers can preferably be from 1 to 40% by weight. The weight data here are based on the entirety of the constituents of the aqueous composition, with the exception of water.

The adhesive according to the invention can advantageously be produced by using high-boiling-point solvents that are not physiologically hazardous and that are not subject to special labelling obligations (Verordnung über Gefahrstoffe [Regulations concerning hazardous substances] of Jan. 10, 1986) of the type represented by the alkyl ethers of di-, tri- and tetraethylene glycol, or else, if appropriate, by using the lower-carboxylic esters of these ethers. Solvents of this type exhibit a certain level of hydrophilic properties and have an advantageous effect particularly during the incorporation of the resins, by reducing the viscosity of the resin melt. They moreover provide the pressure-sensitive adhesive with long-lasting constant tack. The alkyl moieties of abovementioned esters of oligoethylene glycols can be those having 1 and 6 carbon atoms, but in particular having 2 and 4 carbon atoms—i.e. the monoethyl and monobutyl ethers, and it is particularly important that the oligoethylene glycol derivatives are not physiologically hazardous. It is also possible to use other hydrophilic high-boiling-point solvents that are not physiologically hazardous, examples being diacetin and 1,4-butanediol. Particularly desired properties can be obtained by varying either the amount or the type of the high-boiling-point solvents.

The adhesive also comprises, alongside the polymer, at least one filler. The adhesive can in particular comprise fillers from the group of chalk, quartz sand, powdered quartz, calcite, dolomite, talc, kaolin, mica, baryte and powdered pumice. It is preferable to use finely ground or precipitated chalks and/or powdered quartz and/or baryte with average particle diameter which is generally from 2 to 50 μm. It is preferable that the adhesive according to the invention comprises from 10 to 200 parts by weight of fillers, based on 100 parts by weight of polymer (dry mass).

The water content of the adhesive is generally from 7 to 50% by weight, in particular from 10 to 30% by weight, based on the entire adhesive.

It is preferable that the adhesive according to the invention comprises at least one further component from the group of auxiliaries and additives, thickeners, antifoams, dispersing agents, emulsifiers, tackifiers, preservatives, light stabilizers and antioxidants, flame retardants and biocides.

In one preferred embodiment, the adhesive according to the invention preferably comprises no plasticizers.

The adhesive according to the invention is preferably also almost free from organic solvents, e.g. butyl acetate and toluene. The amounts that it comprises of organic compounds with boiling point below 300° C. at atmospheric pressure (1 bar) are therefore preferably below 0.5% by weight, particularly preferably below 0.1% by weight, very particularly preferably below 0.05% by weight and in particular below 0.01% by weight. The weight data here are based on the entirety of all of the constituents of the aqueous composition, with the exception of water. It is particularly preferable that the adhesive satisfies requirements of freedom from emission defined by the Gemeinschaft Emissionskontrollierter Verlegewerkstoffe [Association for the Control of Emissions in Products for Flooring Installation] (GEV).

A chamber test method is used to determine the emissions. 300 g/m² of the floorcovering adhesive or, respectively, the composition according to the invention are applied to a glass plate, the size of which depends on the volume of the chamber. The loading level of the chamber is 0.4 m² of coated glass plate per m³ of chamber volume. The emission conditions in the stainless-steel test chamber (volume at least 125 litres) are 23° C., 50% rel. humidity and an hourly air change rate which results in replacement of all of the air every 2 hours. Long-term emissions are determined after 10 days. For this, a defined volume of the air flow is passed over adsorbents. After desorption, the emitted substances are determined by gas chromatography (MS-coupled GC) or by liquid chromatography. Long-term emissions are determined in μg/m³, using toluene as standard substance. Emitted substances with concentration greater than 20 μg/m³ in the chamber are identified and calibrated using the pure identified substance. Emitted substances with concentrations smaller than 20 μg/m³ in the chamber are not individually identified. In these instances, toluene is used for calibration. The values for all of the substances are added.

The total emissions from the adhesive according to the invention after 10 days are preferably less than 500 μg/m³.

The adhesive is suitable as adhesive for floorcoverings, in particular for wall-to-wall carpets or other floorcoverings with textile underside (e.g. jute), polyester non-woven, rubber coverings, and textile coverings, including for example also those with various backings (such as polyurethane foam, styrene-butadiene foam, textile secondary backings), needlefelt floorcoverings, and linoleum coverings, on substrates such as wood, screed, concrete and ceramic tiles.

The adhesive is particularly suitable for the adhesive bonding of PVC (in embodiments in the form of multilayer coverings or homogeneous coverings), and is very particularly suitable for the conductive adhesive bonding of conductive PVC floorcoverings to raised floors. The adhesive according to the invention is particularly suitable for the adhesive bonding of PVC and rubbery materials to absorbent substrates, such as cement screed, lime plaster and gypsum plaster, concrete, wood and wood-based materials.

The adhesive can by way of example be applied to the substrate by a toothed applicator. After conventional air-drying, the floorcovering is laid onto the adhesive. The adhesive according to the invention has a good level of performance characteristics, e.g. peel resistance, shear resistance, wet peel strength and dry peel strength.

Leak resistance is measured by a method based on EN 13415. In one preferred embodiment, the leak resistance of the adhesive according to the invention is less than 3×10⁵ ohms, where the test specimen is stored for 10 days at 50° C. and for one day at 20° C. prior to the test.

In particular, the adhesive also exhibits, for a prolonged period after application, markedly higher conductivity than the known adhesives based on aqueous polymer dispersions.

The examples below illustrate the advantages of the present invention.

### EXAMPLES

Conductive adhesive for a floorcovering (data in % by weight):

| | | (According to | |
|---|---|---|---|
| | | the invention) | (Comparison) |
| | | Formulation 1 | Formulation 2 |
| Acrylate/acrylonitrile | Binder | 13.0 | 53.0 |
| dispersion | | | |
| Polyester poly- | Binder | 40.0 | — |
| urethane dispersion | | | |
| Agitan 282 | Antifoam | 0.1 | 0.1 |
| 10% strength sodium | Stabilizer | 0.8 | 1.0 |
| hydroxide solution | | | |
| Fatty alcohol | Wetting agent | 0.9 | 0.9 |
| polyglycol ether | | | |
| Sylvamelt 401 | Resin melt | 6.5 | 6.5 |
| Water | | 3.4 | 3.2 |
| Na polyacrylate salt | Dispersing | 1.0 | 1.0 |
| | agent | | |
| Acticide MBS | Preservative | 0.3 | 0.3 |
| Timcal KS 44 | Carbon Black | 22.0 | 22.0 |
| C11 baryte | Filler | 12.0 | 12.0 |
| | | 100.0 | 100.0 |

The individual components were homogenized in a mixing vessel by using a dissolver stirrer. Resistance is tested by a method based on EN 13415. A film of thickness about 1 mm and width 10 cm is drawn onto a conductive PVC floorcovering (Lingoplan AL 90). Two copper strips are attached, 50 cm apart, and resistance is measured between these.

Formulation 1 (according to the invention) rises from 5×10³ ohms after 24 hours to about 20×10³ ohms after heat-aging (10 days at 50° C. and one day at 20° C.). Formulation 2 (comparison) rises from 3×10³ ohms after 24 hours to about 1×10¹⁰ ohms after heat-aging (10 days at 50° C. and one day at 20° C.).

Resistance is not permitted to exceed 3×10⁵ ohms.

1. Adhesive for a floorcovering, comprising, based on the entire adhesive,
from 5 to 30% by weight of at least one component selected from graphite and carbon black and/or from 0.2 to 3% by weight of conductive carbon fibres,
from 25 to 50% by weight of a polyurethane dispersion with solids content of from 25 to 65% by weight,
where less than 5% by weight of an aqueous dispersion of polyhydroxyether polymer, grafted with at least one acrylic or methacrylic monomer, with solids content of from 25 to 40% by weight, is present.

2. Adhesive according to claim 1, wherein the polyurethane dispersion comprises polyester polyurethane, polyether polyurethane or acrylate polyurethane or a mixture thereof.

3. Adhesive according to claim 1, wherein the adhesive comprises graphite with an average particle diameter of from 10 to 70 μm.

4. Adhesive according to claim 1, wherein the leak resistance thereof is less than 3×10⁵ ohms, measured to EN 13415, where the test specimen is stored for 10 days at 50° C. and for one day at 20° C. prior to the test.

5. Adhesive according to claim 1, comprising, based on the entire adhesive, from 1 to 20% by weight of a further polymer dispersion comprising polymers of: C₁-C₂₀-alkyl(meth)acrylates, vinyl esters of carboxylic acids, where these acids comprise from 1 to 20 carbon atoms, vinylaromatics having from 1 to 20 carbon atoms, ethylenically unsaturated nitriles, vinyl halides, non-aromatic hydrocarbons having at least 2 conjugated double bonds, or a mixture of the said monomers, and the polymers can comprise, based on solids content, from 0 to 40% by weight of further monomers, optionally monomers having functional groups.

6. Adhesive according to claim 5, wherein the glass transition temperature of the polymer of the further polymer dispersion is from −50 to 20° C.

7. Adhesive according to claim 1, comprising no plasticizers.

8. Adhesive according to claim 1, comprising at least one filler from the group of chalk, quartz sand, powdered quartz, calcite, dolomite, talc, kaolin, mica, baryte and powdered pumice.

9. Adhesive according to claim 1, comprising from 10 to 200 parts by weight of fillers, based on 100 parts by weight of polymer.

10. Adhesive according to claim 1, wherein the content of organic compounds with boiling point below 300° C. (1 bar), based on the entire adhesive, is smaller than 0.5% by weight.

11. Adhesive according to claim 1, wherein at least one further component is present from the group of auxiliaries, additives, thickeners, antifoams, dispersing agents, emulsifiers, tackifiers, preservatives, light stabilizers, antioxidants, flame retardants and biocides.

12. Adhesive according to claim 1, wherein the water content, based on the entire adhesive, is from 7 to 50% by weight.

13. (canceled)

14. (canceled)

15. A method of adhesive bonding a floorcovering on a substrate comprising applying the adhesive of claim 1 to the substrate and laying the floorcovering onto the adhesive.

16. The method of claim 15 wherein the floorcovering comprises PVC or a rubbery material.

17. The method of claim 16 wherein the substrate is an absorbent substrate.

18. The method of claim 17 wherein the absorbent substrate comprises cement screed, lime plaster, gypsum plaster, concrete, wood, or wood-based material.

19. The method of claim 15 wherein the floorcovering comprises wall-to-wall carpet, a floorcovering with textile underside, polyester non-woven covering, rubber covering, textile covering optionally wherein the textile covering has a backing of polyurethane foam, styrene-butadiene foam, or a textile secondary backing, needlefelt floorcovering, or linoleum covering, and the substrate comprises wood, screed, concrete or ceramic tile.
